(19) United States
(12) Patent Application Publication
(10) Pub. No.: US 2004/0130866 A1
(43) Pub. Date: Jul. 8, 2004

(54) Electronic apparatus having holder to absorb shock applied to disk unit

(75) Inventors: Hiroaki Itakura, Ome-shi (JP); Noriyasu Kawamura, Yokohama-shi (JP); Naohiro Yokoyama, Akishima-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/664,921

(22) Filed: Sep. 22, 2003

(30) Foreign Application Priority Data
Oct. 31, 2002 (JP) 2002-318061

(51) Int. Cl. G06F 1/16

(52) U.S. Cl. 361/685

(57) ABSTRACT

An electronic apparatus has a housing. The housing contains a module and a holder to support the module. The holder is interposed between the housing and the module. The holder has a plurality of shock absorbing parts contacting the inside of the housing.

### CROSS-REFERENCE TO RELATED APPLICATIONS

This application is based upon and claims the benefit of priority from the prior Japanese Patent Application No. 2002-318061, filed Oct. 31, 2002, the entire contents of which are incorporated herein by reference.

### BACKGROUND OF THE INVENTION

1. Field of the Invention

The present invention relates to an electronic apparatus which contains a computer module such as a magnetic disk unit or an optical disk unit in a housing. In particular, the present invention relates to a structure to reduce a shock transmitted from the housing to the computer module.

2. Description of the Related Art

An electronic apparatus such as a book-type portable computer contains a magnetic disk unit capable of reading and writing a large quantity of data. The magnetic disk unit has a flat box-like main body. The main body contains a magnetic disk, a carriage to support a magnetic head, a spindle motor to rotate the magnetic disk, and other various components.

U.S. patent application No. 5,731,952 discloses an electronic apparatus which contains a magnetic disk unit. The electronic apparatus has a box-like housing. The housing has a receptacle to contain the magnetic disk unit. The receptacle is sized according to the main body of the magnetic disk unit. A metallic bracket is fixed to the main body of the magnetic disk unit. The bracket is fixed to the housing through a plurality of screws. In this way, the magnetic disk unit is held by the receptacle in the housing.

In recent electronic apparatus, the housing has been made thin to increase the portability. As the housing is made thin, the thickness of the housing is decreased and the gap between the housing inside and the magnetic disk unit becomes very small. Thus, if the electronic apparatus is accidentally dropped on the floor, the housing cannot absorb the shock. As a result, the shock is directly transmitted from the housing to the magnetic disk unit, causing a problem or a malfunction of the magnetic disk unit.

### BRIEF SUMMARY OF THE INVENTION

According to an embodiment of the present invention, there is provided an electronic apparatus comprising a housing; a module contained in the housing; and a holder to support the module. The holder is interposed between the housing and the module, and has a plurality of shock absorbing parts contacting the inside of the housing.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a perspective view of a portable computer according to an embodiment of the present invention;

FIG. 2 is a sectional view of the portable computer showing the state that a magnetic disk unit is contained in a receptacle of a housing;

FIG. 3 is a sectional view of the portable computer showing a positional relationship between a spring piece of a holder and a bottom wall of the housing;

FIG. 4 is a perspective view of the portable computer showing the stage that the magnetic disk unit is fixed to the housing through a screw;

FIG. 5 a perspective view of the portable computer showing the state that the holder is fixed to the bottom wall of the housing;

FIG. 6 is a perspective view showing the external views of the holder and the magnetic disk unit; and

FIG. 7 is a perspective view showing a positional relationship between the holder and the magnetic disk unit.

### DETAILED DESCRIPTION OF THE INVENTION

Embodiments of the present invention will be explained hereinafter with reference to the attached drawings.

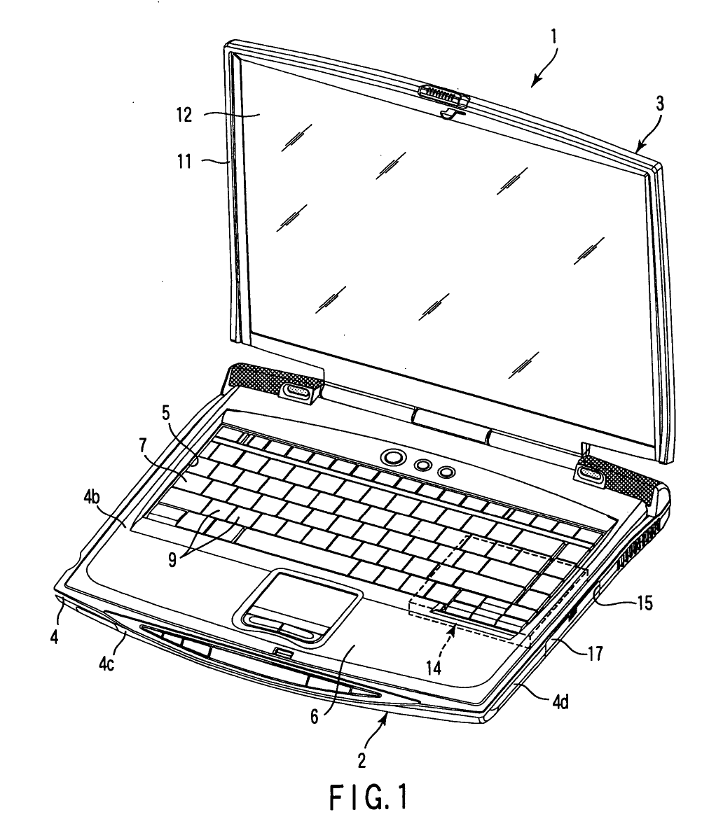

FIG. 1 shows a portable computer 1 as an electronic apparatus. The portable computer 1 comprises a computer main unit 2 and a display unit 3. The computer main unit 2 has a flat box-like housing 4. The housing 4 is made of metallic material, for example, magnesium alloy. The housing 4 has a bottom wall 4a, an upper wall 4b, a front wall 4c, left/right side walls 4d, and a rear wall (not shown). The upper wall 4b has a keyboard mounting part 5 and a palm rest 6.

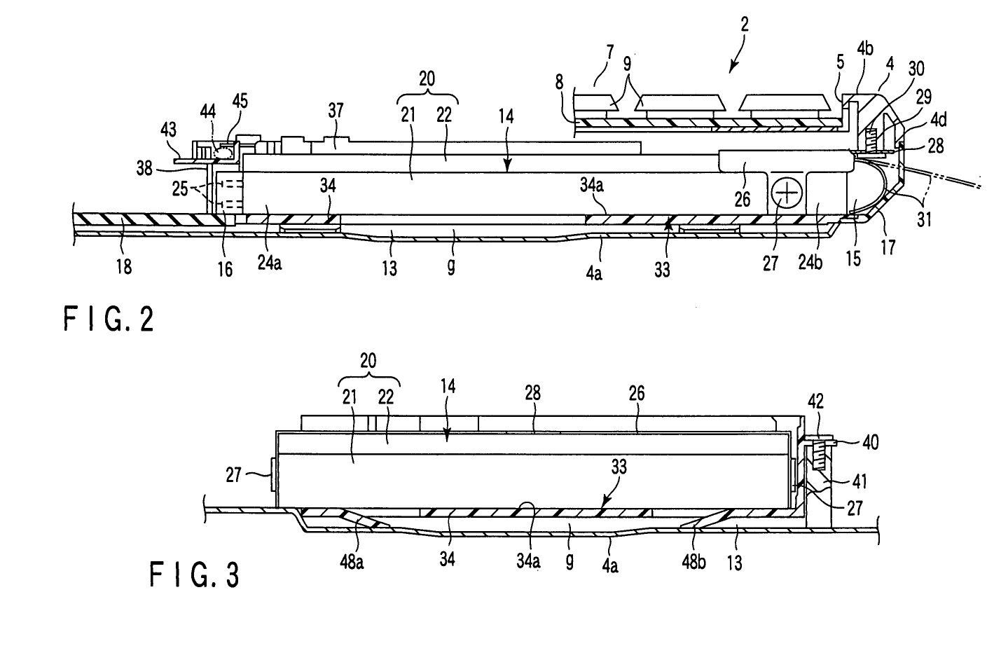

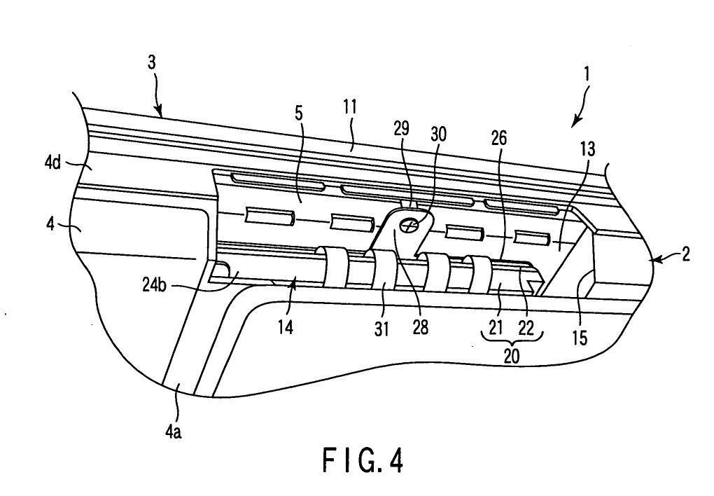

As shown in FIG. 2, the keyboard mounting part 5 supports a keyboard 7. The keyboard 7 has a keyboard panel 8 and many key-tops 9. The keyboard panel 8 is fitted in the keyboard mounting part 5. The key-tops 9 are arranged on the keyboard panel 8. The palm rest 6 is the part on which the operator puts his hand when using the keyboard 7. The palm rest 6 is located in front of the keyboard 7, extending in the width direction of the housing 4.

A display unit 3 has a display housing 11, and a liquid crystal display panel 12 contained in the display housing 11. The display housing 11 is supported at the rear end of the housing 4 through a hinge. Thus, the display unit 3 is rotatable between a closed position and an opened position. In the closed position, the display unit 3 lies on the housing 4, covering the palm rest 6 and keyboard 7 from above. In the opened position, the display unit 3 rises from the housing 4, exposing the keyboard 7 and liquid crystal display panel 12.

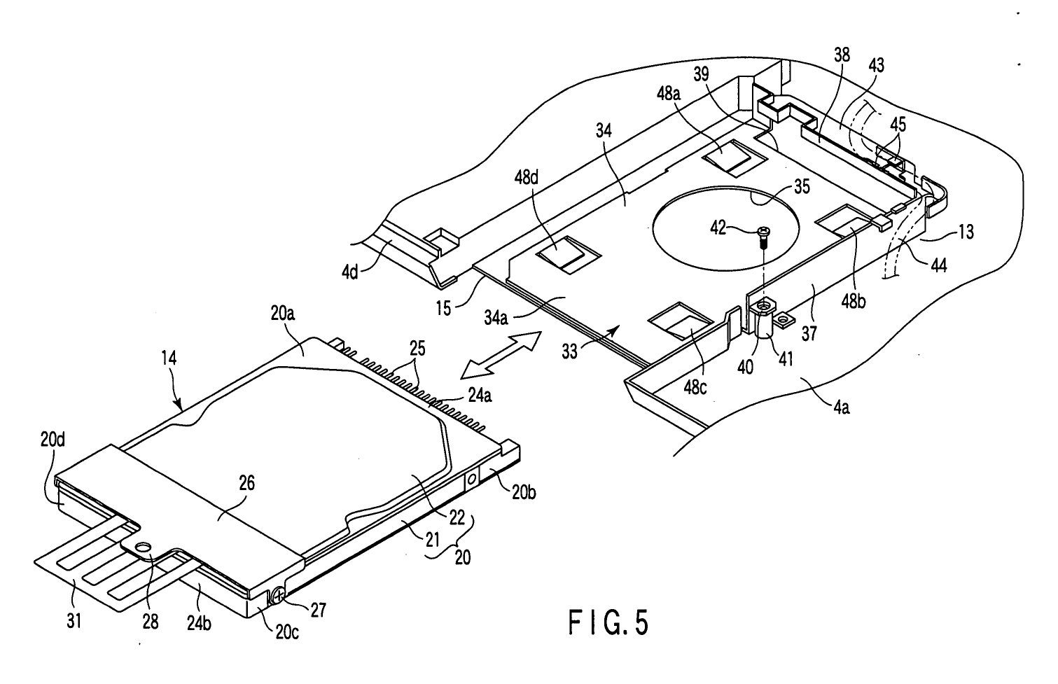

As shown in FIG. 2 and FIG. 5, the housing 4 has a receptacle 13 inside. The receptacle 13 is to contain a magnetic disk unit 14 as a computer module. The receptacle 13 is located between the right end part of the keyboard 7 and the bottom wall 4a of the housing 4.

The receptacle 13 has a slot 15 to insert and remove the magnetic disk unit 14, and a connector 16 to connect the magnetic disk unit 14. The slot 15 opens in the right side wall 4d of the housing 4, and is covered by a removable cover 17. The connector 16 is supported by a printed circuit board 18, facing the slot 15.

As shown in FIG. 5 to FIG. 7, the magnetic disk unit 14 has a main body 20. The main body 20 is a flat rectangular box having four corners 20a-20d. The main body 20 has a base 21 and a top cover 22 fixed to the base 12. The top cover 22 forms a clean closed space between the base 21. The closed space contains a plurality of magnetic disks, a carriage having a magnetic head, a spindle motor 23 to rotate the magnetic disks, and other various components. The end of the spindle motor 23 is exposed to the bottom of the base 21.

As shown in FIG. 2, the main body 20 has a first end 24a facing the connector 16, and a second end 24b facing the slot 15. Pin terminals 25 are arranged at the first end 24a of the main body 20. The pin terminals 25 are removably connected to the connector 16.

A metallic bracket 26 is fixed to the second end 24b of the main body 20 through screws 27. The bracket 26 has a tongue piece 28 extending toward the slot 15 from the second end 24b. The tongue piece 28 is fixed to a boss 29 projecting from the inside of the upper wall 4b of the housing 4 through a screw 30. The part of the boss 29 fixed to the tongue piece 28 is covered by the cover 17.

Thus, the magnetic disk unit 14 is held horizontal in the receptacle 13 of the housing 4, by inserting the pin terminals 25 into the connector 16, and fixing the tongue piece 28 of the bracket 26 to the boss 29.

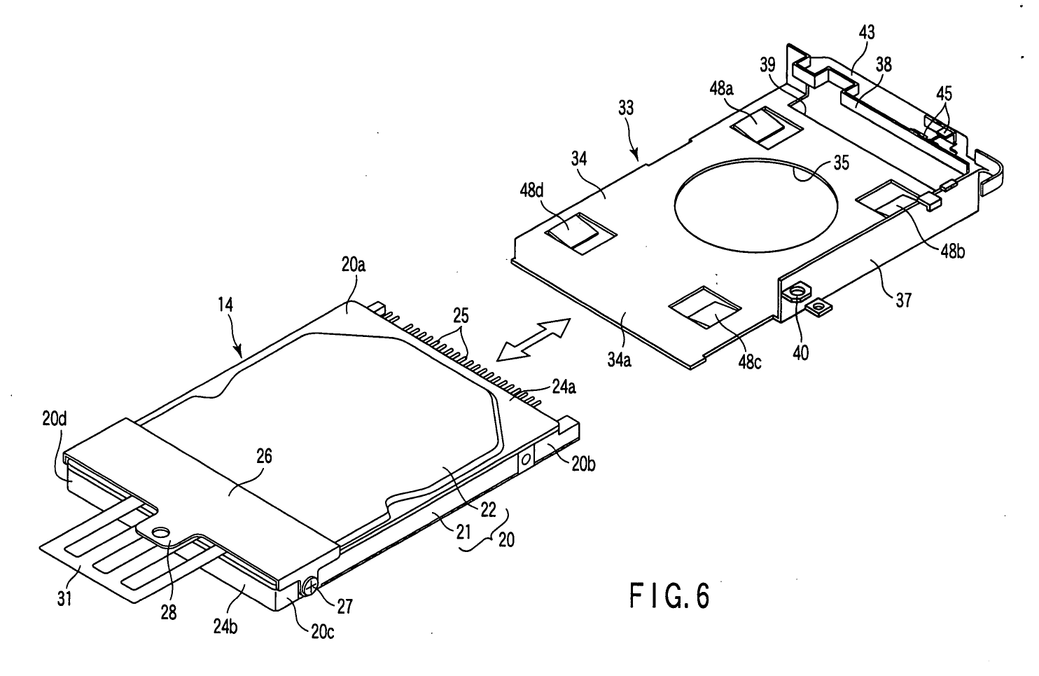

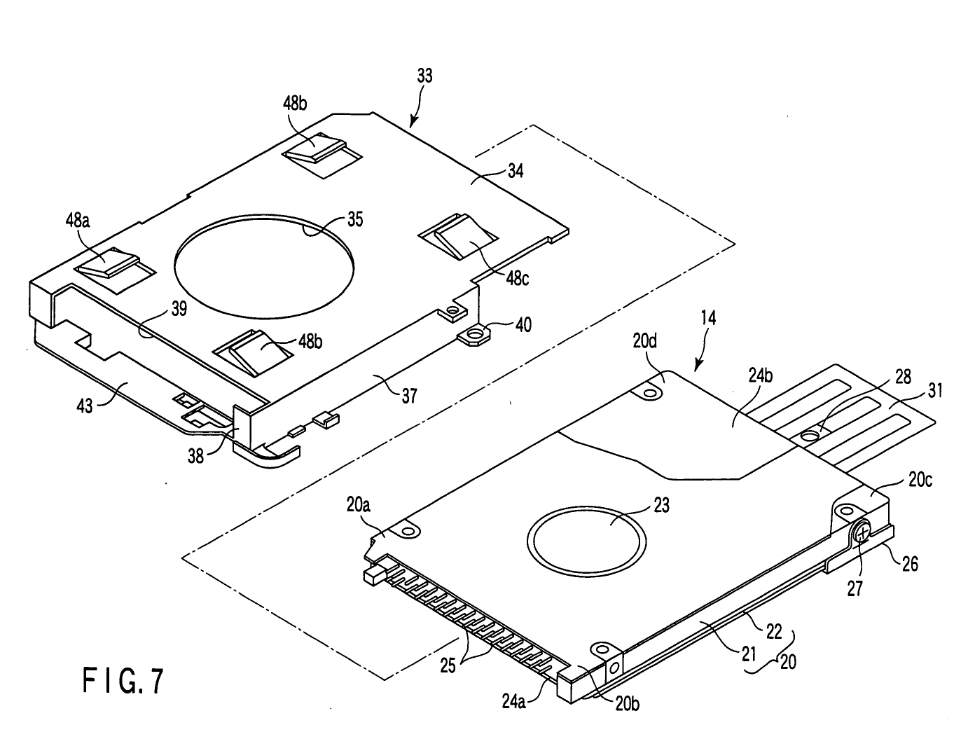

As shown in FIG. 5 and FIG. 6, a flexible ribbon 31 is fitted to the second end 24b of the main body 20. The ribbon 31 is to be held by fingertips when taking out the magnetic disk unit 14 from the receptacle 13. The ribbon 31 is housed between the cover 17 and the second end 24b of the magnetic disk unit 14.

When the cover 17 is removed from the housing 4, as shown by a double-dashed line in FIG. 2, the ribbon 13 projects to the side of the housing 4 through the slot 15. Thus, the magnetic disk unit 14 can be pulled out from the receptacle 13, by holding and pulling the ribbon 13 with the fingertips after releasing the tongue piece 28 from the boss 29.

As shown in FIG. 2 and FIG. 5, a synthetic resin holder 33 is provided in the receptacle 13. The holder 33 is used to support the magnetic disk unit 14. The holder 33 has a guide plate 34. The guide plate 34 is interposed between the bottom wall 4a of the housing 4 and the magnetic disk unit 14. The guide plate 34 is rectangular and sized corresponding to the main body 20 of the magnetic disk unit 14. The guide plate 34 is located between the slot 15 and the connector 16, and arranged horizontally along the magnetic disk unit 14. The upper surface of the guide plate 34 is made as a flat guide surface 34a, on which the base 21 of the main body 20 contacts slidably. Thus, when the magnetic disk unit 14 is inserted into the receptacle 13 through the slot 15, the main body 20 of the magnetic disk unit 14 is guided to the connector 16 along the guide surface 34a.

The guide plate 34 has an opening 35. The opening 35 is formed at a position opposite to the spindle motor 23 of the magnetic disk unit 14. The opening 35 is larger than the end of the spindle motor 23 exposed to the bottom of the base 21. In other words, the opening 35 prevents contact between the guide plate 34 and the end of the spindle motor 23. The end of the spindle motor 23 goes into the inside of the opening 35.

The guide plate 34 has a standing wall 37 at the edge of one side along the length direction. The standing wall 37 is provided to guide the inserting direction of the magnetic disk unit 14, extending linearly along the width direction of the housing 4. The guide plate 34 has an end wall 38 adjacent to the standing wall 37. The end wall 38 stands opposite to the first end 24a of the magnetic disk unit 14. A connector exit 39 is formed at the corner defined by the end wall 38 and the guide plate 34. The connector exit 39 is notched to avoid the connector 16.

As shown in FIG. 3 and FIG. 5, a tongue piece 40 is formed in the standing wall 37 of the holder 33. The tongue piece 40 extends horizontally from the standing wall 37, and is fixed to a boss 41 projecting from the bottom wall 4a of the housing 4 through a screw 42. Thus, the holder 33 is fixed to the bottom wall 4a of the housing 4, and kept in the constant position with respect to the slot 15 and connector 16. A little gap g is formed between the bottom wall 4a and the guide plate 34 of the holder 33.

As shown in FIG. 2 and FIG. 5, the holder 33 has a cable guide wall 43 at the upper end of its end wall 38. The cable guide wall 43 extends horizontally over the whole length of the end wall 38, and is located above the connector 16.

A cable 44 is wired along the upper surface of the cable guide wall 43. The cable 44 is to make electrical connection between a not-shown electric fan, for example, and the printed circuit board 18. The cable 44 is removably hung on a plurality of engaging pieces 45 formed in the cable guide wall 43. Thus, the wiring route of the cable 44 is defined in the housing 4.

As shown in FIG. 2, FIG. 5 and FIG. 6, the guide plate 34 of the holder 33 has four spring pieces 48a-48d as shock absorbing parts. The spring pieces 48a-48d are formed as one body in the guide plate 34 when the holder 33 is injection molded. The spring pieces 48a-48d are formed in the guide plate 34, corresponding to the four corners 20a-20d of the magnetic disk unit 14. Each of the spring pieces 48a-48d projects obliquely downward from the guide plate 34 to the bottom wall 4a of the housing 4, and can be elastically deformed in the thickness direction of the housing 4. Further, the spring pieces 48a-48d are arranged to the gap g, and the forward ends of them butts against the inside of the bottom wall 4a. Therefore, the spring pieces 48a-48d support the guide plate 34 to mount the magnetic disk unit 14, floating against the bottom well 4a.

With this structure, if the portable computer 1 is accidentally dropped on the floor or pressed against a desk by a strong force, a large shock causing deformation may be applied to the bottom wall 4a of the housing 4.

The magnetic disk unit 14 in the housing 4 is mounted on the guide plate 34 of the holder 33, and the spring pieces 48a-48d are interposed between the guide plate 34 and the bottom wall 4a. Thus, when an external shock is applied to the bottom wall 4a, the spring pieces 48a-48d are elastically deformed according to the strength of the shock, and absorb the shock to be transmitted from the bottom wall 4a to the magnetic disk 14.

As a result, the shock to be applied to the magnetic disk unit 14 is reduced, and the shock-resistance of the magnetic disk unit 14 is increased. Therefore, a malfunction or a problem of the magnetic disk unit 14 can be prevented, and the data recorded in the magnetic disk unit 14 can be prevented from being damaged.

In the above-mentioned embodiment, the magnetic disk unit 14 is arranged under the keyboard 7, but the present invention is not to be restricted by this arrangement. For example, if there is not enough space to contain the magnetic disk unit 14 under the keyboard 7, it is also permitted to arrange the magnetic disk unit 14 under the palm rest 6.

When this configuration is adopted, the palm rest 6 is not merely the place to put the operator's hand, but the place to abut the display unit 3 when the display unit 3 is closed. Thus, it is unavoidable to apply a shock to the palm rest 6.

Therefore, when the magnetic disk unit 14 is arranged under the palm rest 6, the holder is to be made like a hollow box, for example, and the magnetic disk unit 14 is to be arranged inside of the holder. A plurality of elastically deformable spring pieces is to be formed projecting upward on the upper surface of the holder, and the forward ends of the spring pieces are to be made contact with the inside of the palm rest 6.

In this configuration, when an external shock is applied to the palm rest 6, each spring piece is elastically deformed according to the strength of the shock applied to the palm rest 6, absorbing the shock to be transmitted from the palm rest 6 to the magnetic disk unit 14.

In the above-mentioned embodiment, the spring pieces are formed in one body with the synthetic resin holder, but the present invention is not to be restricted by this structure. For example, it is permitted to mount a plurality of metallic spring pieces on the synthetic resin holder. Further, it is also permitted to form a plurality of spring pieces in one body with a metallic holder.

In the present invention, a module to be housed in a housing is not restricted to a magnetic disk unit. For example, a CD-ROM unit, an optical disk unit and other computer modules such as a modem unit can be used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a housing;
a module contained in the housing; and
a holder to support the module, the holder interposed between the housing and the module, and having a plurality of shock absorbing parts contacting the inside of the housing.

2. The electronic apparatus according to claim 1, wherein the holder has a guide plate on which the module is mounted, and the shock absorbing parts are formed on the guide plate.

3. The electronic apparatus according to claim 2, wherein the shock absorbing parts support the guide plate of the holder, floating against to the housing.

4. The electronic apparatus according to claim 2, wherein the module includes a main body which has a plurality of corners, the guide plate of the holder has a size corresponding to the main body, and the shock absorbing parts are formed on the guide plate, corresponding to the corners of the main body.

5. The electronic apparatus according to claim 2, wherein the housing has a bottom wall, the guide plate of the holder is interposed between the bottom wall and the module, and the shock absorbing parts of the holder project from the guide plate to the bottom wall, elastically contacting the bottom wall.

6. The electronic apparatus according to claim 2, wherein the housing includes a receptacle to contain the module, and the receptacle has a slot to insert the module and a connector opposite to the slot and connected to the module, and the holder is located between the slot and the connector.

7. The electronic apparatus according to claim 2, wherein the module is a disk unit.

8. The electronic apparatus according to claim 7, wherein the disk unit has a main body and a motor exposed outside of the main body, and the guide plate of the holder has an opening into which the motor is inserted.

9. The electronic apparatus according to claim 1, wherein the holder is made of synthetic resin, and the shock absorbing parts are formed in one body with the holder.

10. An electronic apparatus comprising:
a housing having a receptacle;
a module contained in the receptacle; and
a holder interposed between the inside of the receptacle and the module, the holder having a guide plate to mount the module, and a plurality of shock absorbing parts projecting from the guide plate toward the inside of the receptacle and contacting the inside of the receptacle.

11. The electronic apparatus according to claim 10, wherein the receptacle of the housing has a slot to insert the module, and a connector opposite to the slot and connected to the module; and the guide plate of the holder is fixed to the housing and located between the slot and the connector.

12. The electronic apparatus according to claim 10, wherein the module includes a main body having a plurality of corners, the guide plate of the holder has a size corresponding to the main body, and the shock absorbing parts of the holder are formed on the guide plate, corresponding to the corners of the main body.

13. An electronic apparatus comprising:
a housing having a slot;
a disk unit inserted to the inside of the housing through the slot;
a guide plate interposed between the inside of the housing and the disk unit, the guide plate having a guide surface slidably contacting the disk unit when the disk unit is inserted through the slot; and
a plurality of spring pieces projecting from the guide plate toward the inside of the housing, and contacting the inside of the housing.

14. The electronic apparatus according to claim 13, wherein the housing includes a receptacle to contain the disk unit, the receptacle has a connector to connect the disk unit, and the guide plate has a wall to guide the disk driving unit from the slot toward the connector.

15. The electronic apparatus according to claim 14, wherein the housing has a bottom wall exposed to the receptacle, and the spring pieces are interposed between the bottom wall and the guide plate, supporting the guide plate floating against the bottom wall.
